(19) United States
(12) Patent Application Publication
(10) Pub. No.: US 2016/0002473 A1
(43) Pub. Date: Jan. 7, 2016

(54) COATING COMPOSITIONS AND METHODS OF USE

(71) Applicant: TERRAPAVE INTERNATIONAL, Austin, TX (US)

(72) Inventor: Yetkin Yildirim, Austin, TX (US)

(21) Appl. No.: 14/768,006

(22) PCT Filed: Feb. 13, 2014
(86) PCT No.: PCT/US2014/016274

§ 371 Date: Aug. 14, 2015

Related U.S. Application Data
(60) Provisional application No. 61/764,897, filed on Feb. 14, 2013.

(51) Int. Cl. C09D 5/00; C09D 195/00; C04B 24/26; C09D 133/00; C04B 41/48; E02D 3/12; C09D 197/00; C09D 1/00; B05D 1/02; E01C 7/35; E01C 7/36; B09B 1/00; C09D 125/04; C09D 7/12

(52) U.S. Cl. CPC C09D 5/002; C09D 125/04; C09D 195/005; C04B 24/26; C09D 133/00; C04B 41/4857; C09D 7/125; C09D 197/005; C09D 1/00; B05D 1/02; E01C 7/356; E01C 7/36; B09B 1/004; E02D 3/12

(57) ABSTRACT

Coating compositions and methods of use are described herein. The coating composition may contain water one or more acrylic compounds. Wherein application of the coating composition as a prime coat to a pavement structure or other permeable structures enhances the physical properties of the pavement structure or other structures as compared to conventional prime coat application or other conventional coatings.

### BACKGROUND

1. Technical Field

The present disclosure relates to coating compositions and uses thereof In particular, the invention relates to coating compositions for treatment of roads and/or other permeable materials.

2. Background

The composition and properties of soils and/or roadbases may vary greatly. Such variations may significantly affect the performance of road surfaces constructed thereon. In many instances, soils must be stabilized prior to the construction of a road surface. Conventional stabilization methods include mechanical methods, such as, for example, compaction and/or mixing fibrous or other reinforcement materials with the soil, and chemical methods, such as, for example, blending binders, water repellents, and/or emulsifiers to the soil to, for example, reduce dusting and modify the behavior of clays within the soil.

Conventional stabilization aids that are mixed with soils include cements, for example, Portland cement, lime, gypsum, fly ash, and polymers. These conventional stabilization aids are be costly and/or difficult to handle and mix with soils. Thus, there is a need to address the aforementioned problems and other shortcomings associated with conventional soil stabilization aids. These needs and other needs are satisfied by the compositions and methods of the present disclosure.

U.S. Pat. Nos. 4,545,820 to Mallow; 4,391,926 to Creyf; 4,464,200 to Duval; 5,746,546 to Hubbs et al.; and 5,670,567 to Lahalth, describe various stabilizers. International Application Publication No. 2012/018416 to Yildirim describes soil stabilizers containing carbonaceous materials.

When used in pavements, the desired function of the asphalt is to bind aggregate particles together in a way that they can effectively carry vehicular loading. Secondly, asphalt prevents water from penetrating into the pavement layers below the riding surface. Asphalt can be used in hot applications after extensive heating, or it can be turned into an emulsion by mixing with water. In hot applications, very high temperatures are required to achieve the desired functional properties. Reaching these temperatures requires significant energy consumption and can be a very expensive process and/or pose safety issues. If proper temperatures are not achieved during the mixing and compaction processes, premature failure of the roadway may occur.

According to ASTM D 8-02 Standard Terminology Relating to Materials for Road and Pavements, a prime coat is an application of a low-viscosity bituminous material to an absorptive surface, designed to penetrate, bond, and stabilize the existing surface and to promote adhesion between it and the construction course that follows. The Asphalt Institute describes a prime coat as a spray application of a medium curing cutback asphalt or emulsified asphalt applied to an untreated base course. The most common type of prime coat is medium curing cutback asphalt, MC-30. A prime coat is applied to the base course of a pavement before construction of any subsequent layers. The main purpose of prime coats is to provide a waterproof base to protect the subsequent layers against wet weather conditions. Another function of prime coats is to bind surface fines together. Prime coat materials can be classified under two main groups: cutback asphalt and emulsified asphalt. Cutback asphalt is a mixture of asphalt cement and petroleum solvent. Emulsified asphalt is a suspension of asphalt cement in water.

Prime coat application has long been a common procedure in the highway industry. Cutback asphalts such as MC-30 persist as the most common prime coat material despite many concerns about these products. Cutbacks are manufactured by combining asphalt with a petroleum solvent, and as a result, these materials release an exceptionally high level of volatile organic compounds (VOCs) into the atmosphere during their curing process. In order for the prime coat to take hold and properly seal the base, sufficient evaporation must occur leaving the suspended asphalt cement as a rigid layer absent of the petroleum solvent. The solvent evaporates into the atmosphere in the form of VOCs. In addition to this negative impact on the atmosphere, cutbacks like MC-30 also pose a health and safety risk to construction personnel. One concern is that cutback asphalt poses a fire hazard with its relatively low flashing point. According to a manufacturer, MC-30 has a flashing point between 120° F. and 140° F. What's more, inhalation of the vapors by construction personnel during installation has side effects such as headache, dizziness, and nausea. In addition, physical exposure to kerosene in cutback asphalt could cause dermatitis. MC-30 also falls short in providing good strength for base layers after application. MC-30 does not sufficiently bind the particles in the base layer and therefore does not provide good strength values. Especially for low volume roads where only a very thin layer is used to cover the base, problems with load bearing capacity is observed in situations where MC-30 is used. Environmentally friendly prime coat alternatives such as EC-30 have shown problems with permeability, while other water-based materials have problems with penetration into the base. If surface moisture is allowed to permeate into the base, or if sufficient penetration of the coat material does not occur, then the prime coat cannot properly function.

Light and heat energy behave differently depending on the color of the surface that light and energy contact. Light, white colored surfaces reflect light and heat energy, while dark, black colored surfaces absorb much of this light and heat energy. Asphalt materials have traditionally been black, and thus, the majority of roadways are dark colored (e.g., black) in color. Dark colored roadways absorb an enormous amount of heat during the day that would otherwise be reflected back into the atmosphere that is subsequently released (for example, at night) when such heat energy would not naturally be present in the area. Thus, black roads may contribute to changes in environmental patterns.

Just as roadway bases are sealed using seal coats in order to protect them from water damage, many different materials are used in wood treatment for the same reasons. If water is allowed to penetrate into wood, then weakening, rot and fungus growth will likely occur. It is not uncommon for hazardous materials to be used in wood treatment. For example, arsenic is still used in many wood treatments. Arsenic replacement materials, such as copper, tantalite, and creosote may pose a health risk to the general public. The health risk may result from treated decayed wood release materials considered toxic into the environment. For example, utility poles such as telephone or power lines are typically wooden poles that have been treated in order to resist adverse weather conditions. Creosote is often used on such poles. Even after application on these poles, the material remains viscous. Over the course of many years, the toxic wood treatment creeps down the pole and into the soil below. Growing concerns about these hazardous materials, coupled with rising prices of these materials, has led to new developments in wood treatment. Today, asphalt emulsions utilizing 25-pen bitumen asphalt are commonly used as a wood treatment in place of arsenic. While effective at reducing moisture penetration, this extremely stiff material is considerably brittle and has a risk of cracking, thus negating its function as a sealant.

In some instances, silty clay is used as a building construction material when dried in the shape of a block. These blocks do not have strong resistance to rain and their service life is only a couple of years depending on the weather and climatic conditions.

Based on the above, better coating compositions for road applications and/or other porous materials are desired.

### SUMMARY

Embodiments described herein relate to coating compositions, methods of making coating compositions and uses thereof

In some embodiments, a coating composition for prime coat applications includes one or more acrylic polymers; and water, wherein application of the coating composition as a prime coat to a pavement structure enhances the physical properties of the pavement structure as compared to conventional prime coat application.

In some embodiments, a method of applying a prime coat to pavement structure includes providing a coating composition to one or more portions of a pavement structure, wherein the coating composition comprises one or more acrylic compounds; and curing the pavement structure for a desired period of time.

In some embodiments, a coating composition for fog coat applications includes one or more spent toners, wherein at least one of the toners is non-black; one or more acrylic polymers; and water, wherein application of the coating composition as a fog coat to a pavement structure enhances the physical properties of the pavement structure.

In some embodiments, a pavement structure composition includes one or more acrylic polymers; and water, wherein the pavement structure composition enhances the physical properties of the pavement structure.

In some embodiments, a coating composition for prime coat applications includes one or more paraffinic resins; and water; wherein application of the coating composition as a prime coat to a pavement structure enhances the physical properties of the pavement structure as compared to conventional prime coat application.

In some embodiments, a coating composition for prime coat applications includes one or more soybean processing by-products; and water, wherein application of the coating composition as a prime coat to a pavement structure enhances the physical properties of the pavement structure as compared to conventional prime coat application.

In some embodiments, a coating composition for prime coat applications includes one or more one or more vinyl acetate compounds; and water, wherein application of the coating composition as a prime coat to a pavement structure enhances the physical properties of the pavement structure as compared to conventional prime coat application.

In some embodiments, a coating composition for prime coat applications includes one or more acrylonitrile butadiene styrene compounds; and water, wherein application of the coating composition as a prime coat to a pavement structure enhances the physical properties of the pavement structure as compared to conventional prime coat application.

In some embodiments, a coating composition for prime coat applications includes one or more styrene-butadiene rubber compounds; and water, wherein application of the coating composition as a prime coat to a pavement structure enhances the physical properties of the pavement structure as compared to conventional prime coat application.

In some embodiments, a coating composition for prime coat applications includes one or more lignin sulfonates; and water, wherein application of the coating composition as a prime coat to a pavement structure enhances the physical properties of the pavement structure as compared to conventional prime coat application.

In some embodiments, a coating composition for prime coat applications includes magnesium chloride; and water, wherein application of the coating composition as a prime coat to a pavement structure enhances the physical properties of the pavement structure as compared to conventional prime coat application.

In some embodiments, a coating composition for prime coat applications includes calcium chloride; and water, wherein application of the coating composition as a prime coat to a pavement structure enhances the physical properties of the pavement structure as compared to conventional prime coat application.

In some embodiments, a method of preparing soil blocks includes providing one or more vinyl acrylic polymers to soil; mixing the acrylic polymer with the soil to form a mixture; and forming the mixture into one or more blocks, wherein the block has increased strength properties as compared to an untreated soil block.

In some embodiments, a method of treating a landfill, comprising providing a coating composition to portion of a landfill, wherein the coating composition comprises one or more vinyl acrylic polymers; allowing the coating composition to dry; and forming a coating on the base of the landfill so that the base of the landfill is substantially impermeable to water.

In some embodiments, a method of treating a water structure includes providing a coating composition to one or more portions of a water structure, wherein at least one of the portions is at a base of the water structure, and wherein the coating composition comprise one or more vinyl acrylic polymers; allowing the coating composition to dry; and forming a coating on the base of the structure so that the structure is substantially impermeable to water.

In some embodiments, a method of treating wood includes providing a coating composition to one or more portions of wood, wherein the coating composition comprise one or more vinyl acrylic polymers; forming a coating on the wood so that the wood is substantially impermeable to water.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings

FIG. 1 depicts bar graphs of the coefficient of permeability in cm/sec of unmodified materials and an embodiment of soil stabilized with carbon black.

FIG. 2 depicts bar graphs of the strength properties in kg/cm² of unmodified materials and an embodiment of soil stabilized carbon black.

FIG. 3 depicts bar graphs of the coefficient of permeability in cm/sec of unmodified materials and an embodiment of soil modified with about 6.5 wt. % carbon black.

FIG. 4 depicts bar graphs of the dry strength properties in kg/cm2 of unmodified materials and an embodiment of soil modified with about 13 wt. % carbon black/

FIG. 5 depicts bar graphs of the wet strength properties in kg/cm2 of unmodified materials and an embodiment of soil modified with about 8 wt. % carbon black.

FIG. 6 depicts a graphical representation of composition vs. wet strength in pounds per square inch (psi) of a prime coat made with a coating composition containing vinyl acrylic latex and conventional prime coats.

FIG. 7 depicts a graphical representation of composition vs. wet strength in pounds per square inch (psi) of a prime coat made with a coating composition containing vinyl acrylic latex and conventional prime coats.

FIG. 8 depicts a graphical representation of composition vs. permeability (cm/s) of a prime coat made with a coating composition containing vinyl acrylic latex and conventional prime coats.

FIG. 9 depicts a graphical representation of composition vs. penetration (mm) of a prime coat made with a coating composition containing vinyl acrylic latex and conventional water based prime coats.

FIG. 10 depicts a graphical representation of composition vs. curing time (hours) for pavement structure after an application of a prime coat made with a coating composition containing vinyl acrylic latex and conventional prime coats.

FIG. 11 depicts a graphical representation of composition vs. permeability (cm/s) of a fog seal application made with a coating composition containing vinyl acrylic latex and untreated pavement.

FIG. 12 depicts a graphical representation of composition vs. water absorption (mg/mm³/hr) for a yellow pine after an application of a coating composition containing vinyl acrylic latex and untreated wood.

While the invention may be susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DESCRIPTION

The present invention is understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Although any methods and materials similar or equivalent to those described herein may be used in the practice or testing of the present invention, example methods and materials are now described.

Unless defined otherwise, all technical and scientific terms used herein have the same meaning as commonly understood by one of ordinary skill in the art to which this invention belongs. Although any methods and materials similar or equivalent to those described herein may be used in the practice or testing of the present invention, example methods and materials are now described.

As used in the specification and the appended claims, the singular forms “a,” “an” and “the” include plural referents unless the context clearly dictates otherwise. Thus, for example, reference to “a polymer” includes mixtures of two or more polymers.

Ranges are expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

“Carbon black” refers to elemental carbon having aciniform morphology (e.g., shaped like a cluster of grapes). Carbon black may have conductive properties.

“Porosity” or “permeability” refers to flow of fluid through a material. Porosity and/or permeability are measured using nitrogen surface area (NSA) and/or statistical thickness surface area (STSA) surface area measurements).

“Carbonaceous” refers to a solid material of substantially elemental carbon. For example, a solid material that includes about 97 wt. % to about 99 wt. % elemental carbon is considered carbonaceous.

“Carbonaceous material” refers to, without limitation, i) carbonaceous compounds having a single definable structure; or ii) aggregates of carbonaceous particles, wherein the aggregate does not necessarily have a unitary, repeating, and/or definable structure or degree of aggregation.

“Particulate” means a material of separate particles.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are varieties of structures that can perform the same function that are related to the disclosed structures, and that these structures will typically achieve the same result.

Coating compositions and uses thereof described herein. The coating composition includes one or more vinyl acrylic compounds. In some embodiments, the coating composition includes vinyl acrylic latex. The use of compounds that may be mixed with water instead of cutback asphalt (for example, MC-30) in prime coat applications for paving produces a more environmentally friendly and safer composition.

Many prime coat applications have petroleum solvents as the base material so that the asphalt material may be dissolved or partially dissolved in the solvent. When the coating composition described herein is mixed with water, an environmentally friendly and safe composition is realized as compared to typical coating compositions is used in prime coat paving applications and/or other applications such as wood treatment at elevated temperatures. For example, a composition that includes vinyl acrylic latex. Thus, upon heating to cure the coating composition only water instead of volatile organic compounds is emitted. Thus, no, or substantially no, volatile organic compounds are emitted to the atmosphere. Due to the ability to replace petroleum solvents with water, the coating composition has a lower flash point, thus may be considered non-flammable.

It has been unexpectedly discovered that the use of a water based coating compositions described herein has superior properties as compared to conventional prime coat materials, in strength testing in both wet and dry conditions. In some embodiments, the coating composition described herein is used as a stabilizer in road applications. The coating composition provides an environmental friendly alternative to other coating compositions. For example, cutback used in prime coat applications.

The coating composition described herein includes additives. The additive may include one or more acrylate compounds, soybean processing by-products, one or more vinyl acetate compounds, one or more acrylonitrile butadiene styrene compounds, one or more rubber compounds, one or more styrene butadiene rubber compounds, one or more paraffinic resins, one or more lignin sulfonates, one or more low molecular weight polymers, one or more soybean processing by-products, magnesium chloride, calcium chloride, or mixtures thereof. In some embodiments, the coating composition includes vinyl acrylate monomer. Acrylate compounds include, but is not limited to, monomers, polymers, and co-polymers of acrylic acid and derivatives acrylic acid. In some embodiments, an acrylate compound is a polymer derived from acrylic acid and vinyl acetate. A commercially available vinyl acrylic polymer latex is ENCOR DC 387 (Arkema Inc., Cary N.C.)

In some embodiments, the coating composition (for example, a composition containing vinyl acrylic polymer and water) may have a pH of from about 3.5 to about 6.5, for example, about 3.5, 3.7, 3.9, 4.1, 4.3, 4.5, 4.7, 4.9, 5.1, 5.3, 5.5, 5.7, 5.9, 6.1, 6.3, or 6.5; or from about 4.5 to about 5.5, for example, about 4.5, 4.6, 4.7, 4.8, 4.9, 5.0, 5.1, 5.2, 5.3, 5.4, or 5.5. In some embodiments, a composition may include at least 10% by weight of vinyl acrylic polymer (latex). For example, a composition may include 10% by weight of vinyl acrylic polymer (latex) and 10% by weight carbonaceous material.

In some embodiments, the coating composition is an aqueous mixture, slurry, suspension or emulsion of the additive. In some embodiments, the coating composition includes a dispersion of the additive in water and/or an aqueous medium. In such an aspect, it is not necessary that the additive have any specific level of dispersion in the water and/or aqueous medium. In one aspect, all or a portion of the additive is at least partially dispersed in the water and/or aqueous medium.

In some embodiments, the coating composition includes a carbonaceous material. The carbonaceous material may a particulate carbonaceous material and/or a finely divided particulate carbon. In some embodiments, the carbonaceous material is carbon black. In some embodiments, the carbonaceous material is a particulate carbon material having a turbostractic structure. A turbostractic structure is a structure in which the basal planes are not in alignment. In some embodiments, particulate carbon material is produced from a flame process.

In some embodiment, the carbonaceous material includes particulate carbonaceous particles (e.g., carbon black) formed from a flame or partial combustion process. In another aspect, carbonaceous material (e.g., carbon black) is produced from a thermal process, for example, without the use of a flame.

In some embodiments, the carbonaceous material (e.g., carbon black) is produced from a petroleum feedstock that, for example, has a high degree of aromaticity. In some embodiments, the carbonaceous material (e.g., carbon black) is derived from a pyrolysis process, such as, for example, a pyrolytic char. In other aspects, the carbonaceous material may include recycled and/or recovered carbon, for example, from a tire recycling process. For example, carbon black produced from waste tires may be used in the coating composition. In other aspects, a carbonaceous material may include activated carbon. It should be understood that the carbonaceous material may include a mixture of varying types of carbonaceous materials. In some embodiments, the carbonaceous material is spent toner.

In various aspects, the surface of any one or more carbonaceous material may include functional groups that may, for example, be hydrophobic or hydrophilic. In one aspect, a carbon black is produced and/or modified such that the surface chemistry thereof is suitable for blending with a particular soil and/or other optional stabilizers. In yet another aspect, a carbonaceous material is heat treated to remove a portion of or substantially all of the surface functional groups from the surface.

In one example, the carbonaceous material has a hydrophilic surface. In another example, the carbonaceous material has a hydrophobic surface. In yet another aspect, the surface chemistry of a carbonaceous material may be specifically tailored to interact with another species.

In another aspect, the carbonaceous material includes an aggregate structure wherein multiple primary particles are agglomerated. In such an aspect, the size and/or morphology of any individual aggregates may vary. In one aspect, the carbonaceous material has a large aggregate size and, for example, a high degree of branching. In such an aspect, the carbonaceous material provides a reinforcing effect to soil particles and/or roadbase surfaces adjacent thereof, and may occlude fluids, such as, for example, hydrocarbons, to increase the viscosity of a mixture of, for example, soil and stabilizing aids. In another aspect, the morphology (e.g., size and degree of branching) of a carbonaceous material may be selected so as to impart one or more desired rheological properties to a soil, a roadbase, or a mixture thereof with a stabilizing aid.

In some embodiments, the carbonaceous material may include a single grade of carbon black. It should be noted that the properties, such as, for example, particle size, aggregate size, morphology, surface chemistry, and the like, are distributional properties, and that even within a single grade of carbon black variations in properties may occur. For example, the carbonaceous material includes a mixture of two or more grades of carbon black. Carbon black materials are commercially available (e.g., Columbian Chemicals Company, Marietta, Ga., USA; Cabot Corporation, Billerica, Mass., USA), and one of skill in the art in possession of this disclosure could readily select an appropriate carbon black material.

A carbon black, if present as all or a portion of a carbonaceous material, includes any grade or mixture of grades of carbon black. In various aspects, a carbon black may include, but is not limited to, one or more of the following ASTM grades: N110, N220, N330, N550, N700, N880, or N990. In one aspect, a carbon black, if present, may have properties similar to a N700 carbon black. In some embodiments, a carbon black, if present, may have a small average primary particle size, for example, less than about 50 nm, less than about 40 nm, or less than about 30 nm.

In some embodiments, the carbonaceous material of the present invention may be mixed with one or more additives described herein. In various aspects, a carbonaceous material may be blended with one or more of lime, cement, gypsum, fly ash, combinations thereof, and/or other paving application aids.

In some embodiments, additive described herein blended with carbonaceous material contacted, and/or blended, with a soil may provide a desired change in the resulting soil. For example, carbon black may reduce permeability and/or water penetration into the pavement structure. In one aspect, the reduction of the water entrance to the road structure may improve durability.

In some embodiments, the coating composition may be contacted with a portion of soil, for example, in a roadbase. In various aspects, the coating composition may be applied to an otherwise unamended, a soil or mixture of soil and other materials to be used as a road surface, a roadbase, or a combination thereof. The degree of mixing and/or uniformity of the resulting soil may vary, and no specific amount of mixing or level of homogeneity is required. A portion of the coating composition may be contacted with soil or may be sprayed onto a soil or roadbase.

In some embodiments, a portion of the coating composition may be mixed and/or blended with a soil or mixture of materials that form a roadbase. For example, a portion of the coating composition may be mixed and/or blended with a soil and/or roadbase such that the coating composition is uniformly or substantially uniformly distributed throughout the material. In yet another aspect, a portion of the coating composition may be mixed and/or blended with a soil or mixture of materials such that the coating composition is not uniformly or substantially uniformly distributed throughout the same.

The additive may be mixed with water in various concentrations. A coating composition may include from about 0.5 parts to about 1.5 parts by weight, for example, about 0.5, 0.6, 0.7, 0.8, 0.9, 1, 1.1, 1.2, 1.3, 1.4, or 1.5 parts by weight of water; and from about 2 parts to about 4 parts by weight, for example, about 2, 2.2, 2.4, 2.6, 2.8, 3, 3.2, 3.5, 3.6, 3.8, or 4 parts by weight of the additive. In some embodiments, about 1 part by weight water, and about 3 parts by weight of the additive is used. It should be understood that the concentrations of any one or more components may vary, and the present invention is not intended to be limited to any particular concentration or range of concentrations. In some embodiments, the coating composition includes from about 0.5 parts to about 1.5 parts by weight, for example, about 0.5, 0.6, 0.7, 0.8, 0.9, 1, 1.1, 1.2, 1.3, 1.4, or 1.5 parts by weight of carbonaceous material.

In some embodiments, the coating composition includes less than about 0.5 parts by weight or greater than about 1.5 parts by weight of carbonaceous material, less than about 0.5 parts by weight or greater than about 1.5 parts by weight of water, and/or less than about 2 parts by weight or greater than about 4 parts by weight of the additive.

The coating composition may be prepared, stored, and/or transported in a ready to use concentration. In another aspect, the coating composition may be prepared in a concentrated form and may be diluted, for example, with water, prior to use. It should be understood that the concentrations recited above may provide a composition suitable for use as-is. In some embodiments, the coating composition includes from about 10%, about 25%, about 50% or about 90% by weight vinyl acrylic latex. In some embodiments, the coating composition includes from about 10% by weight to about 30% by weight carbon black and/or from about 10% by weight to about 90% by weight vinyl acrylic latex.

In some embodiment, the additive and/or coating composition may be diluted with water in a ratio of from about 1:1 to about 1:10 (parts by weight of concentrate: diluent water), for example, about 1:1, 1:2, 1:3, 1:4, 1:5, 1:6, 1:7, 1:8, 1:9, or 1:10, prior to use. In a specific example, the additive may be prepared and then diluted about 1:5 with water before use.

In some embodiments, one or more stabilization aids, such as, for example, Portland cement, lime, gypsum, fly ash, may be added to the coating composition. If added, a conventional stabilization aid may be present in any suitable concentration, such as, for example, from about 0.1 parts by weight to about 10 parts by weight, or more.

The components of the coating composition, such as, for example, water, and vinyl acrylic latex may be contacted and/or mixed in any manner suitable for an intended application. In one aspect, no specific order of addition and/or degree of mixing is required. In another aspect, the components may be contacted and mixed prior to use such that the coating composition is homogeneous or substantially homogeneous.

In some embodiments, carbonaceous material and at least a portion of the additive may be contacted prior to the addition of water and/or any other components. In still another aspect, the carbonaceous material and additive may be contacted prior to the addition of water. Once at least two of the components are contacted, the mixture may optionally be mixed using any conventional means, such as, for example, a slow rotational mixer in a blending tank. In one aspect, a mixer element and/or means for mixing may move through at least a portion of the mixture, for example, in a continuous up and down manner, until the mixture is at least partially blended. It should be understood that particular carbonaceous materials may be difficult to disperse and that the use of such carbonaceous materials may, in some aspects, require the use of energetic mixing methods, such as, for example, high shear mixers. In other aspects, no specific degree of mixing and/or dispersion is required.

The coating compositions may, in some embodiments, have a solids content of from about 40% to about 60%, for example, about 40, 45, 50, 56, or 60%. In one embodiment, a coating composition has a solids content of about 56%. In other embodiments, a coating composition may have a solids content of less than about 40% or greater than about 60%.

The coating composition may also have a Brookfield viscosity of from about 250 centipoise (cP) to about 600 cP, for example, about 250, 300, 350, 400, 450, 500, 550 or 600 cP. In some embodiments, a coating composition has a Brookfield viscosity of about 500 cP.

A coating composition, as described herein, may be applied to any soil or roadbase surface. In one aspect, a soil or roadbase surface may be scarified prior to application of a coating composition. In some embodiments, a surface should be at least partially stabilized and compacted prior to application of the coating composition. In other embodiments, a surface should be stabilized and well compacted prior to application of the coating composition. In another aspect, the concentration of a coating composition may vary depending on, for example, the type of surface and degree of compaction thereof. For example, a coating composition may be diluted with a greater amount of water when applied to a well compacted soil and/or roadbase surface, so as to facilitate greater penetration of the coating composition into the soil and/or roadbase. In contrast, a coating composition may be applied in a more concentrated (or less diluted) form when applied to a less compacted and/or granular soil or roadbase surface. Such a soil or roadbase surface may, in some aspects, be more difficult to compact, and are thus more suitable for a higher concentration of coating composition. In yet another aspect, a coating composition may be applied to an uncompacted or partially compacted soil or roadbase surface, and then the soil or roadbase surface may optionally be compacted after the application. It should be understood that an appropriate concentration and/or dilution level is used for a particular soil and/or roadbase surface.

In another aspect, the coating composition may be utilized as an additive in a surface coating, such as, for example, a chip seal and/or asphalt coating. In such an aspect, the coating composition may provide extended wear of the surface to which the coating is applied and/or an improved appearance for the coated surface.

The coating composition may be applied to a soil or roadbase surface in any suitable manner. For example, the coating composition may be sprayed, for example, from a water truck, using a pressurized spray system. The pressure and application rate should be such that the spray pattern provides an even or substantially even distribution of coating composition on the soil or roadbase surface. In another aspect, the coating composition may be applied in a seamless manner, such that only a small overlap, if at all, exists between portions of the treated (e.g., sprayed) soil or roadbase surface. The coating composition may be sprayed using other known methods of spraying, for example, a hose, wand, or non-pressurized systems. In some embodiments, a non-spraying method may be utilized. For use in a prime coat application spray application rate on compacted base layer before the placement of the next pavement layer ranges between 0.03 gal/sqyd to 0.60 gal/sq. yd.

The coating composition may be applied as a single layer application or as multiple layers. In one aspect, a single application of the coating composition may be made to provide a single layer on the soil and/or roadbase surface. In another aspect, multiple applications of the coating composition may be made, wherein each layer may be in contact with the previous layer of applied coating composition or in contact with a different layer. For example, multiple layers of varying composition of the coating composition containing different additives may be applied to a soil or roadbase surface. In such an aspect, it is not necessary that any one or more layers comprise a continuous layer across the soil or roadbase surface. In some embodiments, one or more applications of a commercially available stabilizer may be applied to a soil or roadbase as a first layer, followed by one or more applications of the coating composition, followed by additional one or more applications of a coating composition of the same or differing composition. In a specific example, two applications of a sealant, such as Top-Seal White, may be applied to a soil or roadbase surface, followed by two applications of the coating composition, followed by a final application of the Top-Seal White sealant.

In some embodiments the coating composition may be applied as a fog coat, for example, as a sprayed slurry, onto a road surface or base therefore. In such an aspect, an applied fog coat layer containing the coating composition may reduce permeability of the surface to which the fog coat is applied. In some embodiments, a fog coat may at least partially seal one or more cracks in the surface to which the fog coat is applied. A fog coat containing the coating composition, if used, may optionally include other components as desired for the intended application.

In another aspect, the coating composition may be used in a tack coat application. In such an aspect, the coating composition may provide a traceless tack coat. In another aspect, the coating composition may improve adhesion between any two or more layers of pavement or road material. In yet another aspect, the coating composition may reduce the permeability between any two or more layers of pavement or road material. In one aspect, if the coating composition is applied as a fog coat and/or a tack coat application, the soil or roadbase surface to which it is applied should be free or substantially free from dust prior to application. In another aspect, the coating composition may be applied to a soil or roadbase surface as-is, without further preparation or cleaning of the surface.

In one aspect, contacting and/or mixing a carbonaceous material and/or a coating composition containing a carbonaceous material may improve one or more properties of a roadbase surface, such as, for example, increasing strength, reducing permeability, reducing the amount of compaction necessary to form a suitable road surface, and increasing the surface smoothness of a road surface.

The properties of the coating composition are such that the coating composition may be applied to a material (for example, a road and/or a wood product) without heating of the coating composition. In some embodiments, the coating composition is stable at above freezing (for example 10 degrees Celsius) to about 70 degree Celsius. Since, the coating composition is stable at ambient temperatures or below, the coating composition may be applied to a roadbase under “cold” conditions. For example, the coating composition may be applied at ambient temperatures or below. The ability to apply the coating composition under “cold” allows treating applications (for example, paving applications) to be performed in colder climates and winter applications.

In some embodiments, the coating composition (for example, a coating composition containing vinyl acrylate polymer or derivatives thereof and/or carbonaceous material (for example, carbon black and/or spent toner) may be mixed with asphalt compounds (for example, asphalt cut-back, asphalt emulsions, or unmodified asphalt) and water and applied to a road surface as described herein.

Under high temperature conditions, for example, temperatures above 80° F. (summer or tropical conditions), asphalt may separate from the road and/or road base under high friction conditions. For example, asphalt may separate from a highly traveled road in the summer due to the friction of the tires on the road. Application of the coating composition as described herein to a road surface may bind to the surface and/or seal the surface, and thus inhibiting or substantially inhibiting the asphalt from separating from the roadbase. Addition of the coating composition may also enhance the friction properties of the road.

In some embodiments, colored spent toner is used in road applications. The color in the spent toner may be sufficient to provide color to the roadbase. For example, a finished road may be red, blue, yellow, or combinations thereof In some embodiments, the coating composition may be mixed with spent toner or pigment to produce a light colored material, which may be used for road surfacing operations (for example, fog seal). In some embodiments, one or more spent pigments are used in the composition. Pavement made with the coating composition containing spent non-black toner may have lower thermal properties (heat absorption) as compared to pavement made with asphalt. Furthermore, the use of spent toner or pigments in pavement recycles the spent toner. In some embodiments, black roads may be lightened by application of a coating composition containing spent non-black toner or pigments. Production of light colored road surfaces may produce aesthetic looking roads for urban planning, and/or enhance roadway markings on the surface of black pavements.

In some embodiments, a coating composition described herein, is used with spent asphalt. For example, asphalt removed from a road may be melted and mixed with a coating composition containing carbonaceous compounds and at least one vinyl acrylic polymer may be mixed and applied to a roadbase.

In some embodiments, after application of the coating composition to a soil or roadbase surface, at least a portion of the coating composition may be bound to the soil or roadbase surface. For example, a vinyl acrylic polymer in the coating composition may bind to the soil or roadbase. Because of the binding, a hardened wear surface may form. In some embodiments, the coating composition may be tightly bound to the soil or roadbase surface after application. In another aspect, the coating composition may have adhesive properties that may ensure that the coating composition will remain bound to the soil or roadbase surface and provide an at least partial barrier to moisture penetration.

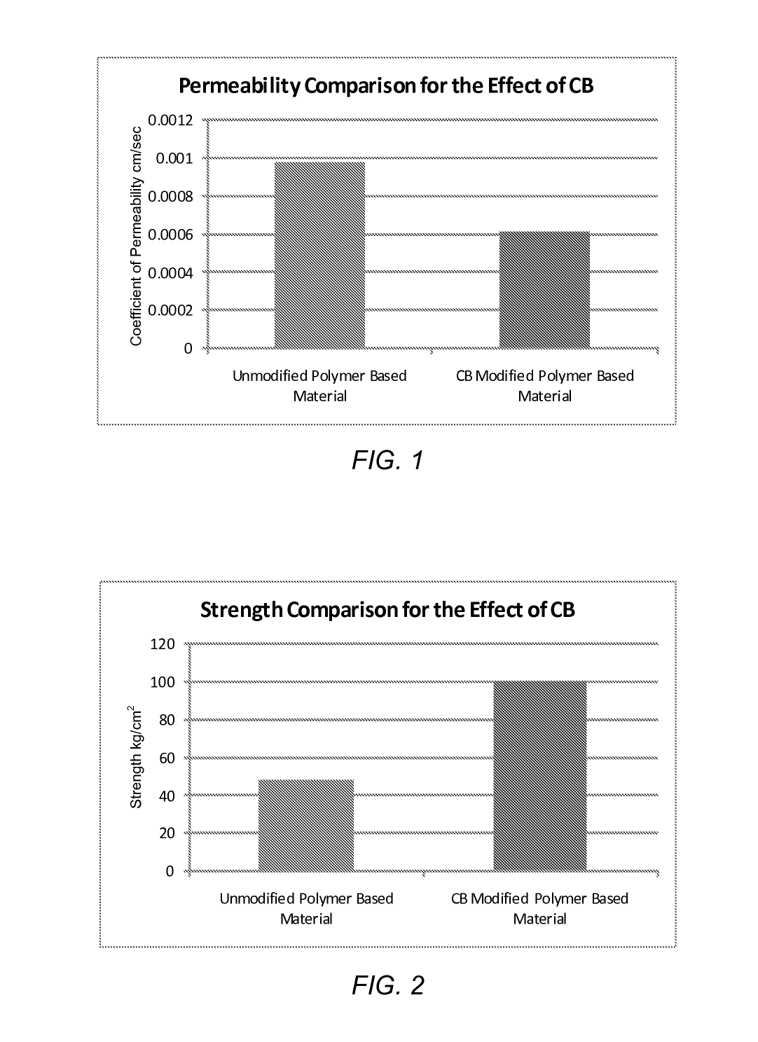

In another aspect, contacting and/or mixing a coating composition containing a vinyl acrylic polymer with a soil may reduce the permeability of the resulting soil to, for example, water. For example, the use of a coating composition containing a vinyl acrylic polymer and carbon black, may reduce the coefficient of permeability (cm/sec) by up to about 35% or more, for example, at least about 20%, at least about 25%, at least about 30%, at least about 35%, at least about 37% or more, as compared to soils containing conventional stabilizers. In some embodiments, use of a coating composition containing carbon black and vinyl acrylic polymer may reduce the coefficient of permeability by about 37.1% as compared to an unmodified material not including a carbon black. FIG. 1 illustrates a reduction in permeability of from 0.000978 cm/sec to 0.000615 cm/sec when using a carbon black containing and the coating composition as a stabilizer as compared to an unmodified polymeric material, such as a sealant.

In some embodiments, contacting and/or mixing a coating composition containing a vinyl acrylic polymer with a soil may increase the strength of the resulting soil. The coating composition may improve the wet strength and/or dry strength of the resulting soil.

In some embodiments, the strength (kg/cm2) of a soil mixed with coating composition containing a vinyl acrylic polymer and a carbonaceous material increases by up to about 100% or more, for example, about 50%, about 60%, about 70%, about 80%, about 90%, about 100%, about 105%, or more over soil stabilized with an unmodified stabilizer not containing a carbonaceous material or vinyl acrylic polymer. In a specific aspect, as illustrated in FIG. 2, a composition including the coating composition and carbon black increases the strength of a soil by about 107.9%, for example, from 48.17 kg/cm2 to 100.14 kg/cm2) as compared to a conventional stabilizer. Wet and/or dry strength of a soil or roadbase surface may be determined using a penetrometer, such as, for example, a pocket penetrometer, available from Durham Geo Slope Indicator, Mulkiteo, Wash., USA. Soil strength may be determined using ASTM test method WK27337.

In some embodiments, contacting and/or mixing a coating composition containing a vinyl acrylic polymer with a soil provides a resulting soil that requires less effort to achieve a desired degree of compaction. In some embodiments, contacting and/or mixing a coating composition containing a vinyl acrylic polymer with a soil provides a road surface having increased surface smoothness.

In some embodiments, soil contacted and/or mixed with the coating composition, exhibits improved workability as compared to unamended soils or soils containing conventional stabilizers.

In some embodiments, soil contacted and/or mixed with the coating composition provides a road surface having improved functional properties as compared to an unamended soil or a soil containing conventional stabilizers.

In some embodiments, a pavement formed on a soil contacted and/or mixed with the coating composition exhibits reduced long-term maintenance costs and/or improved performance over unamended soils or soils containing conventional stabilizers.

In some embodiments, the coating composition (for example, a coating composition containing vinyl acrylic latex) is used as a prime coat in road construction. The mixture may be applied as an aqueous emulsion, suspension, or neat to a base layer. The resulting prime coat mixture penetrates into the base layer and may coat and/or bond loose material properties on the surface of the base layer. The resulting prime coat mixture may also harden or toughen the base layer, protect the base layer from moisture and/or provide adhesion between the base layer and the succeeding layer of the road construction and/or paving.

In some embodiments, using the coating composition as a prime coat may improve the wet strength and/or dry strength of the resulting road. The strength (kg/cm2) of a paved road treated with a prime coat containing the coating composition (for example, containing a vinyl acrylic polymer) increases by up to about 100% or more, for example, about 50%, about 60%, about 70%, about 80%, about 90%, or more over roads treated with conventional prime coat composition. In some embodiments, applying using the coating composition as a prime coat in paving applications may reduce the permeability of the resulting pavement to, for example, water. For example, the use of a coating composition containing a vinyl acrylic polymer may produce improved or similar road permeability properties treated with conventional prime coats.

In some embodiments, coating compositions described herein when used as a prime coat in paving application reduces the permeability and/or water penetration into the pavement structure. Some prime coat materials are available that use water rather than a petroleum solvent. However, these materials suffer from an inability to sufficiently penetrate into the base. Deeper penetration of the prime coat material into the base results in a more durable surface. It has been unexpectedly found that the coating compositions described herein have higher penetration depths as compared to other water based prime coat material.

The time that it takes for pavement structure to cure after application of a prime coat may take at least 100 hours or more. This long curing time leads to delays in use of roads. Applying a prime coat containing the coating compositions described herein may have a curing time of less than 100 hours.

In some embodiments, coating compositions for fog seal applications are made by mixing vinyl acrylic latex with spent toner, carbon black, grinded old tire rubbers, pigments, or mixtures thereof. In some embodiments, the coating composition contains vinyl acrylic latex. Use of the coating composition in fog seal application may result in better penetration results as compared to conventional fog seal application. Better penetration results in a less slippery riding surface and, thus driving safety of the road is enhanced. In some embodiments, use of a coating composition in a fog seal application lowers the permeability of the pavement structure. Lower permeability may reduce aging of pavements by preventing oxidation.

In some embodiments, the coating composition is used as an alternative to asphalt or asphalt modifier. Since the coating composition is a water based, liquid material it may be mixed with aggregate without heating or minimal heating. The use of no or minimal heating may result in significant savings in energy and production costs, and/or negate the risks associated with the high temperatures required for hot-applied asphalts. The coating composition provides similar or better bonding properties than asphalt while making the pavement structure impermeable. In some embodiments, the coating composition may be used with asphalt to modify its properties for the same usage. When the coating composition is used as an asphalt modifier, the amount of asphalt used in the application is reduce, engineering properties of the asphalt are enhanced.

In some embodiments, the coating composition may be used in pavement patching, micro surfacing, slurry seals, crack sealing, and pavement recycling processes.

In some embodiments, a coating composition may be used to seal minor cracks in a road surface. Cracks may be sealed using a fog seal method. A fog seal is designed to coat, protect and rejuvenate the existing asphalt binder. During the fog seal, material (emulsion) to be applied must fill the voids in the surface of the pavement. Therefore, during its application it must have sufficiently low viscosity so as to not break before it penetrates the surface voids of the pavement. This is accomplished by using a slow setting emulsion that is diluted with water. Emulsions that are not adequately diluted with water may not properly penetrate the surface voids resulting in excess asphalt on the surface of the pavement after the emulsion breaks, which can result in a slippery surface.

In some embodiments, the coating composition when mixed with aggregates may be used as patching materials for pavement repair and/or to increase the friction coefficient for roads losing their friction properties. For example, when a coating composition that includes vinyl acrylic polymer and selected aggregates is provided to a pavement structure, a high friction surfaces may be formed.

In some embodiments, the coating composition may be used as a binder to replace asphalt in micro surfacing, slurry seals applications.

Due to the engineering properties of asphalt, the attractive appearance of asphalt shingles, and the industries level of familiarity with asphalt shingles a substantial portion of residential roof shingles contain asphalt. For examples, asphalt shingles are substantially impermeable which allows the shingles to be effective throughout annual temperature fluctuations.

In some embodiments, the coating composition is used as a replacement for or in combination with asphalt to produce asphalt shingles. In some embodiments, a coating composition that includes one or more vinyl acrylic polymers may have enhanced performance through climate fluctuations due to the coating compositions having lower temperature susceptibility (e.g., more consistent viscosity and high and low temperatures), and enhanced impermeability characteristics. Temperature susceptibility refers to the ability of a compound to be fluid enough at elevated temperatures to permit it to be mixed with aggregates, but viscous enough at normal air temperatures to hold aggregates in place. In some embodiments, the coating composition may be mixed with spent toner or pigments to provide different colors for roofing.

In some embodiments, the coating composition may seal in soil blocks and bind the particles together such that the service life of the soil blocks and their structural properties may be improved. In some embodiments, one or more soil blocks are produce from a mixture of soil and one or more vinyl acrylic polymers (for example, vinyl acrylic latex). For example, a coating composition that includes a vinyl acrylic latex may be mixed with soil and formed into a block. An amount of vinyl acrylic latex may range from 15 mL to about 35 mL for every 1000 liters of soil. The resulting blocks may have dimensions of 30 cm (12 inches) length, 15 cm (6 inches) width, and 7.5 cm (3 inches) thickness. Blocks may be made with or without internal holes (for example, 6.66 cm (2.64 inches) holes). Soil blocks be used for buildings and for straight walls, corners, columns, colored walls, and semi-heat resistant or impermeable walls.

In some embodiments, soil blocks are made from a combination of soil, one or more vinyl acrylic compounds, and cement. For example, one bag (94 pounds (42.6 kilograms)) cement per 450 liters of soil and about 5 mL to about 20 mL of vinyl acrylic latex may be mixed together and formed into block. Depending on the amount of mortar, about 45 soil blocks per square meter may be produced.

In some embodiments, the coating composition may be used to treat wood. Typically wood is treated with compounds containing arsenic to kill fungus. The wood, however, when burnt releases arsenic to the air, which may be harmful when inhaled. Concerns about direct exposure as well as concerns about contaminated soil have resulted in a need for a non-hazardous alternative for wood treatment that does not present the problem of brittleness posed by 25 pen asphalt. A coating composition that includes vinyl acrylic polymer may be used to treat wood to inhibit insect and/or fungus infestation. Wood treated with the coating composition (for example, a coating composition containing vinyl acrylic latex) may have the same or similar impermeable properties as wood treated with hazardous materials.

In some embodiments, the coating composition may be applied to on soil, pond or artificial lake constructions. The coating composition may form an impermeable layer. In some embodiments, the coating composition binds soil particles together and provides strength to the soil. As a result of these properties, the coating composition may be in landfill applications by forming an impermeable layer as opposed to liners, which are difficult to install. In some embodiments, the coating composition may be used for erosion control due to its engineering characteristics.

In some embodiments, a method of treating a landfill includes providing the coating composition to one or more portions of a landfill. The portions may include side wall and/or a base of the landfill. For example, a coating composition that includes a vinyl acrylic latex may be sprayed on a base portion of the landfill. The coating composition may be allowed to dry. After drying a coating is formed on the treated soil that is impermeable or substantially impermeable to water or moisture.

In some embodiments, a method of treating a water structure includes providing the coating composition to one or more portions of a water structure. The water structure may be a pond, artificial lake, or other similar water structures. The portions may include side wall and/or a base of the water structure. For example, a coating composition that includes a vinyl acrylic latex may be sprayed on a base portion of the water structure. The coating composition may be allowed to dry. After drying, a coating is formed on the treated portion that is impermeable or substantially impermeable to water.

After placing fresh concrete, satisfactory moisture content must be maintain within the concrete for the sake of a chemical reaction called “hydration” that occurs during the curing process. Exposed slab surfaces are especially sensitive to curing. Surface strength development can be reduced significantly when curing is defective. Most freshly mixed concrete contains considerably more water than is required for complete hydration of the cement; however, any appreciable loss of water by evaporation or otherwise will delay or prevent hydration. Retaining water during this period is important. Good curing means evaporation should be prevented or reduced. Multiple methods are currently used in order to minimize the amount of evaporation that occurs following concrete installation. One method is to spray the fresh concrete with liquid, membrane-forming compounds to act as a moisture barrier. A second method is to cover the fresh concrete with polyethylene sheets. Lastly, some fresh concrete are covered with saturated burlap in order to maintain moisture.

In some embodiments, vinyl acrylic latex's impermeability properties results in its standing as a viable candidate for use in the hydration process of concrete curing. As stated above, one method used during the curing of concrete is to spray the surface with a thin layer of sealant in order to trap the existing moisture within the fresh concrete installation. As a water-based sealant material, vinyl acrylic latex provides the desired characteristics for application atop fresh concrete. A thin layer of vinyl acrylic latex (0.02 lb/ft² to 0.06 lb/ft²) will seal the concrete surface and protect the lower layer from excessive evaporation. The color of the vinyl acrylic latex application may also be controlled by adding waste toner and/or pigments to the vinyl acrylic latex mixture. Without sacrificing any performance characteristics, vinyl acrylic latex may be modified to achieve the desired appearance of the concrete surface.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

A test section was constructed to evaluate the effectiveness of application of composition containing a coating composition carbon black on soil. The amount of carbon black in the composition was determined based on lab design work. Conventional stabilizers not containing carbon black were mixed with carbon black. Using a laboratory design, the convention stabilizer and carbon black were mixed at a 3 to 1 ratio respectively. After mixing is completed, this new mixture was combined with water at a 4 to 1 ratio respectively to elongate its shelf life. This new mixture was shipped to a test section where it is mixed with water at a 1 to 5 ratio respectively before application on the road surface. After the application of this material on the road surface, compaction is applied to the road.

### Example 2

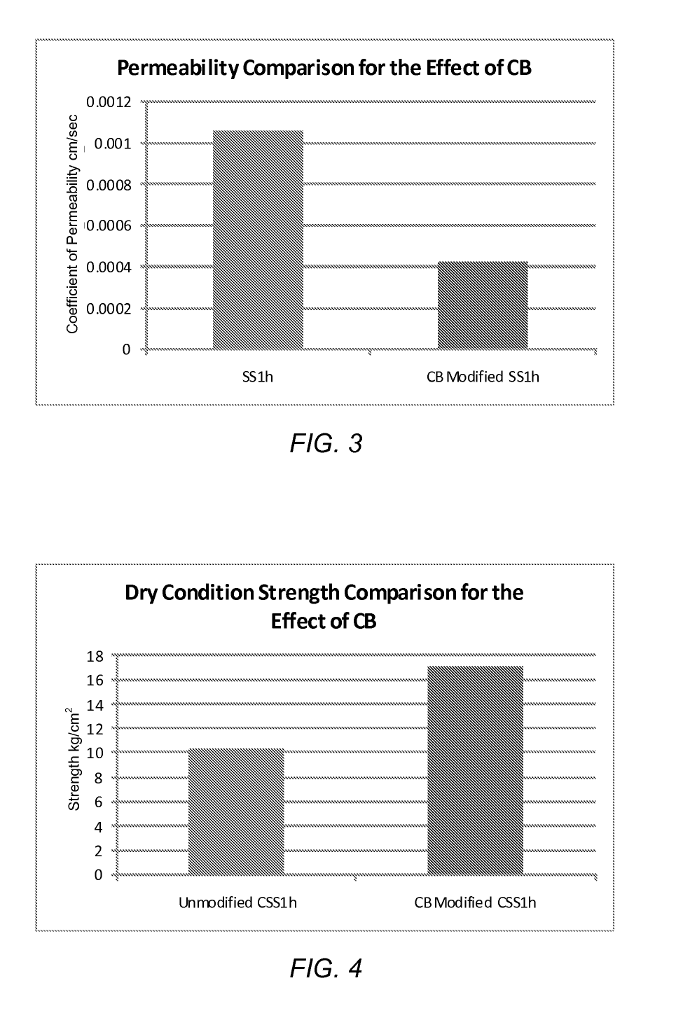

An unmodified asphalt emulsion (SS1h) not containing an added carbon black was applied to a soil. In comparison, a modified SS1h asphalt emulsion containing about 6.5 wt. % carbon black was added to a separate portion of the soil. The unmodified emulsion exhibited a Saybolt viscosity at 77° F. of about 55 SSU (Saybolt seconds Universal), a specific gravity of about 1.019 at 60° F., as determined by gallon weight cup, a distillation residue of about 66.03%, having an oil portion of about 0.45% and a penetration residue at 77° F. of about 95 penetration unit (p.u.) The permeability of each of the resulting soils was measured. As illustrated in FIG. 3, the permeability of the soil treated with carbon black modified coating composition was significantly reduced, from greater than about 0.001 cm/sec to about 0.0004 cm/sec.

### Example 3

An unmodified asphalt emulsion (CSS1h) not containing carbon black was applied to a soil. In comparison, a modified CSS1h asphalt emulsion containing about 13 wt. % carbon black was added to a separate portion of the soil. The unmodified emulsion exhibited a Saybolt viscosity at 77° F. of about 25 SSU (Saybolt seconds Universal), a specific gravity of about 1.0416 at 60° F., as determined by gallon weight cup, a distillation residue of about 61.69% , having no detectable oil portion and a penetration residue at 77° F. of about 82 p.u. The dry condition strength of each of the resulting soils was measured. As illustrated in FIG. 4, the dry strength of the soil treated with carbon black modified coating composition was significantly increased, from about 10 kg/cm2 to about 17 kg/cm2.

### Example 4

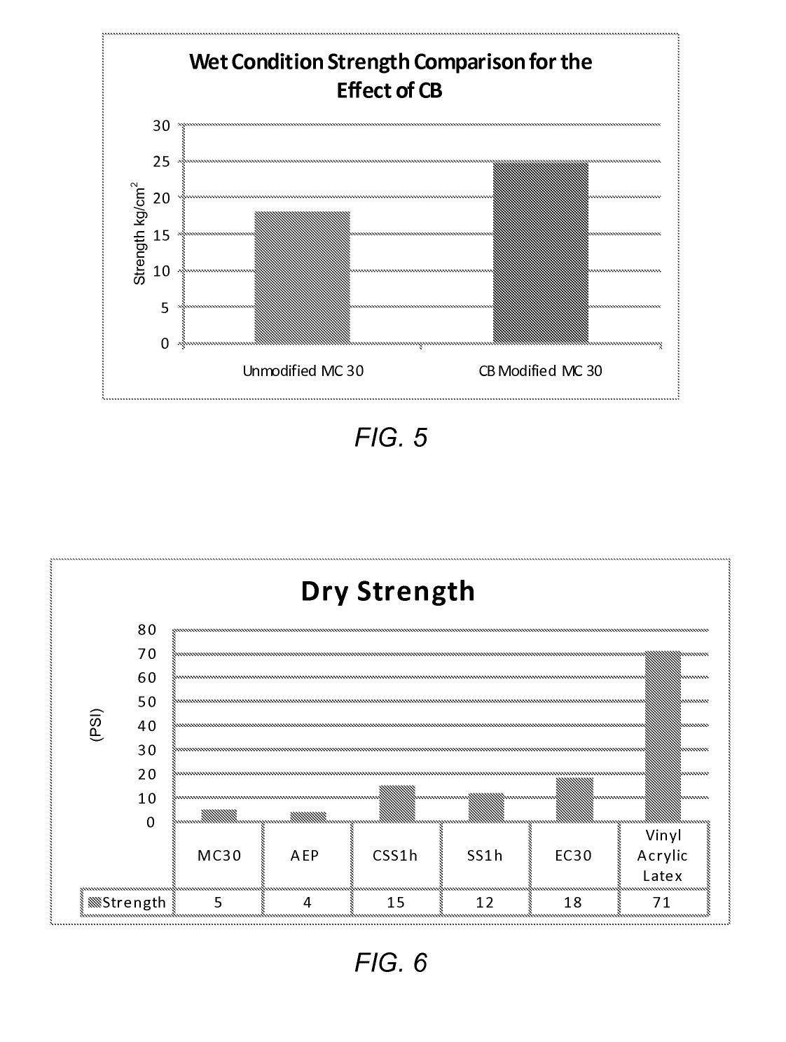

An unmodified asphalt cutback (MC 30) not containing carbon black was applied to a soil. In comparison, a modified MC 30 asphalt cutback containing about 8 wt. % carbon black was added to a separate portion of the soil. The unmodified asphalt cutback exhibited a kinematic viscosity at 140° F. of about 51.13 centistokes (cSt), a specific gravity of about 0.9265 at 60° F., as determined by hydrometer, a distillation residue of about 56.95% by volume, having portions of distillate to 437° F., 500° F., and 600° F., of 21.18%, 58.82%, and 88.24%, respectively, a penetration residue at 77° F. of about 186 p.u., and an absolute viscosity at 140° F. of about 661.93 P. The wet condition strength of each of the resulting soils was measured. As illustrated in FIG. 5, the wet strength of the soil treated with carbon black modified coating composition was significantly increased, from about 18 kg/cm2 to greater than about 24 kg/cm2.

### Example 5

Prime Coat Application. Testing of prime coat applications was conducted using 473 ml (16 oz.) circular sample cans 10.2 cm (4 inches) in diameter and 6.1 cm (2.4 inches) in height. These cans were filled with 300 grams of crushed limestone compacted with a wooden rammer The prime coat material was sprayed onto the top of the specimens. The application rate was 1.23 L/m² (0.27 gallon per square yard). A 10 ml of prime coat was applied for all conventional specimens other than the composition containing vinyl acetate latex. The vinyl acetate latex composition was prepared by diluting vinyl acetate latex with water 1 to 5 ratio. The water based prime coat was applied to specimens.

Dry strength tests were performed on each specimen after the curing of the prime coat material. Strength values were acquired by applying a pocket penetrometer to the cured prime coat surface. For each specimen, strength was measured in five locations and the average of these values produced the sample's strength value. FIG. 6 depicts a graphical representation of composition vs. wet strength in pounds per square inch (psi) of a prime coat made with a coating composition containing vinyl acrylic latex and conventional prime coats.

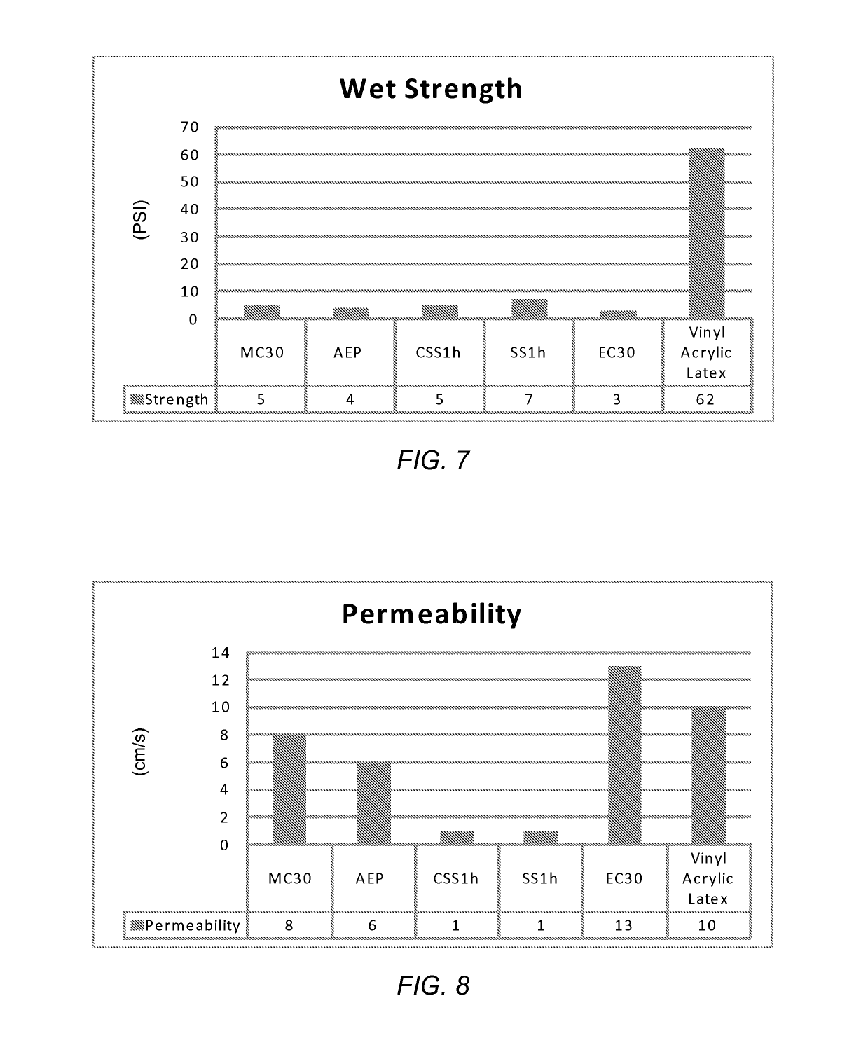

Wet strength tests were performed on each specimen after completion permeability testing (which results in a wet sample). Strength values were acquired by applying a pocket penetrometer to the cured prime coat surface. For each specimen, strength was measured in five locations and the average of these values produced the sample's strength value. FIG. 7 depicts a graphical representation of composition vs. wet strength in pounds per square inch (psi) of a prime coat made with a coating composition containing vinyl acrylic latex and conventional prime coats.

Permeability tests were performed by weighing each specimen after the prime coat material was allowed to cure. Next, 100 ml of water was poured into each specimen. The water was left in the specimen for 10 minutes. After this time, the water that remained on the surface of the specimen was decanted and weighed. The amount of water left subtracted from the original 100 ml results in the amount of water that managed to permeate through the seal coat material. FIG. 8 depicts a graphical representation of composition vs. permeability (cm/s) of a prime coat made with a coating composition containing vinyl acrylic latex and conventional prime coats.

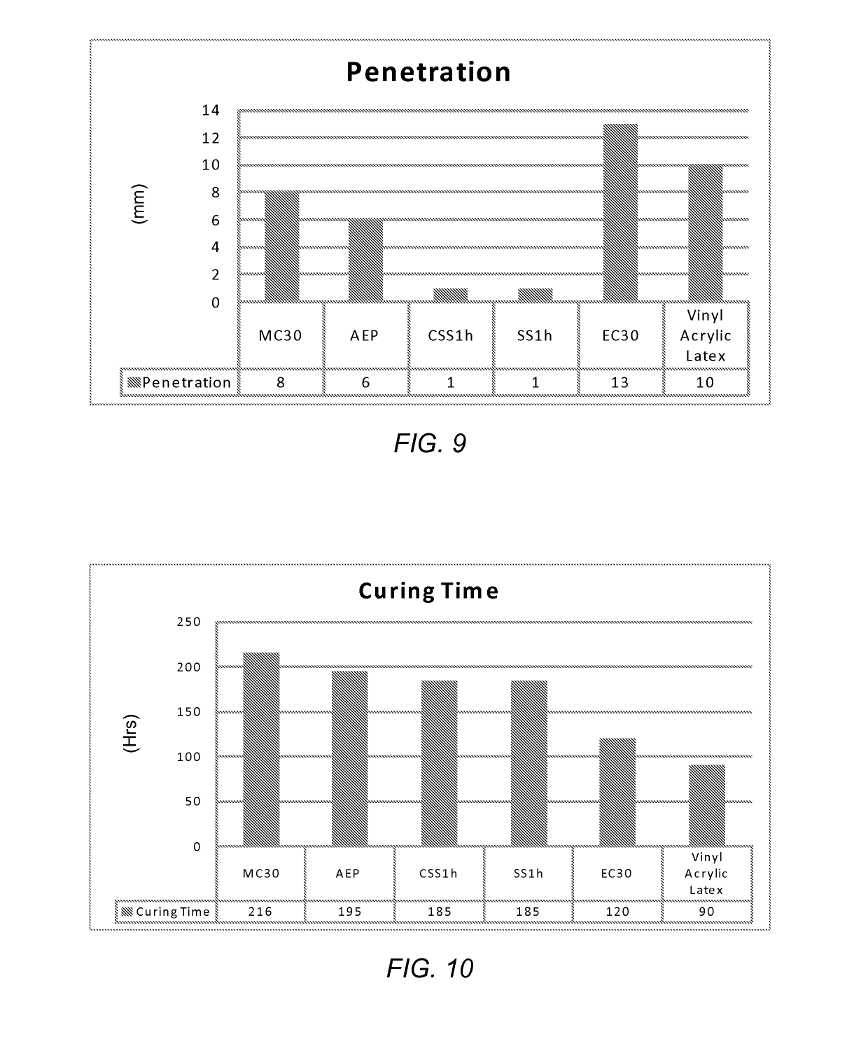

Penetration tests on the samples were performed by placing five grams of prime coat material was poured onto the surface of the sand at a constant rate from a height of approximately 11 cm. The prime coat material was allowed to stand in the sample cans for 24 hours. After the waiting period, the specimen was cut vertically in order to view the penetration depth achieved by the prime coat material. Depth of penetration was measured with a caliper. FIG. 9 depicts a graphical representation of composition vs. penetration (mm) of a prime coat made with a coating composition containing vinyl acrylic latex and conventional water based prime coats.

Curing of Pave Coat Applications. After the samples were prepared, they were exposed to the natural weather to cure. The test was conducted when average temperatures ranged from 23.1° C. to 38.6° C. The sample were not left outside to cure during rain fall. Specimen weight was measured regularly to determine the curing time based on the weight change. Once the weight change stabilizes, curing time was recorded for the sample. FIG. 10 depicts a graphical representation of composition vs. curing time (hours) for pavement structure after an application of a prime coat made with a coating composition containing vinyl acrylic latex and conventional prime coats.

### Example 6

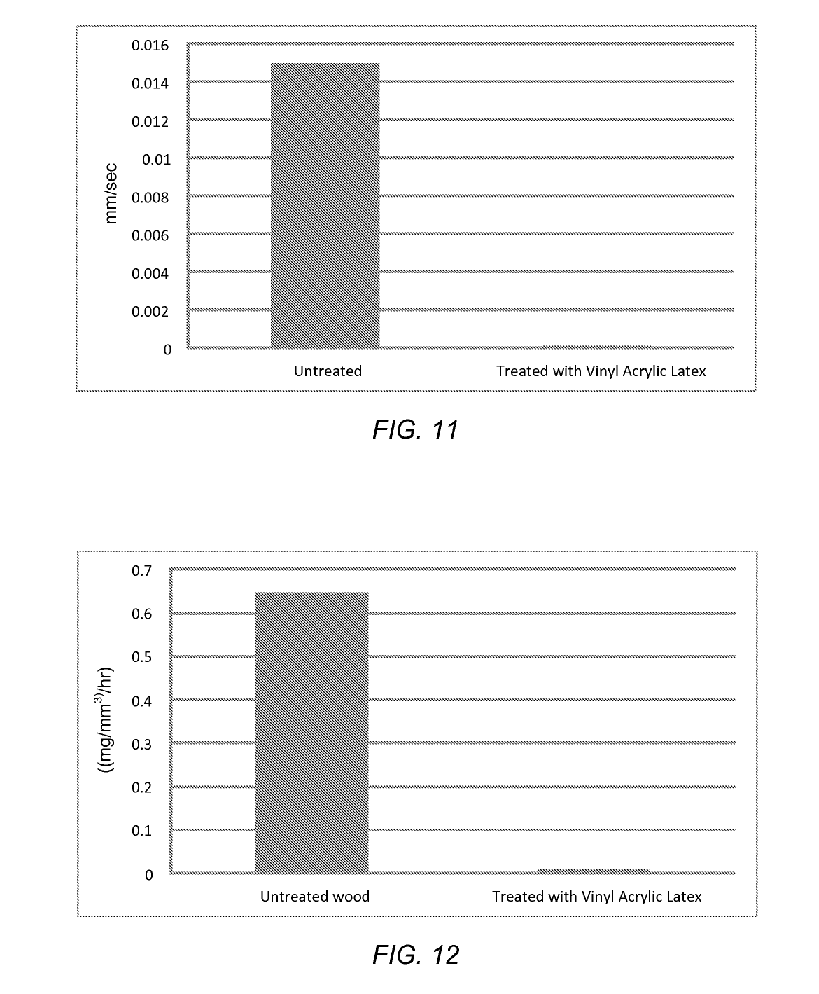

Fog Seal Application. Compacted hot mix asphalt specimens were merged into vinyl acrylic latex and water mixture for 2 hours for two times. Control specimens were not treated with any fog seal materials. After curing completed treated and untreated specimens merged into water for 1 hour. Water absorption is measured based on the change in the weight at the end of 1 hour period. FIG. 11 depicts a graphical representation of composition vs. permeability (cm/s) of a fog seal application made with a coating composition containing vinyl acrylic latex and untreated pavement.

### Example 7

Wood Treatment. Yellow pine specimens were merged into a vinyl acrylic latex and water mixture for 8 hours for two times. Control specimens were not treated. After curing completed treated and untreated specimens merged into water for 2 hours. Water absorption is measured based on the change in the weight at the end of 2 hour period. FIG. 12 depicts a graphical representation of compositions vs. water absorption (mg/mm³/hr) for a yellow pine after an application of a coating composition containing vinyl acrylic latex and untreated wood.

In this patent, certain U.S. patents and U.S. patent applications have been incorporated by reference. The text of such U.S. patents and U.S. patent applications is, however, only incorporated by reference to the extent that no conflict exists between such text and the other statements and drawings set forth herein. In the event of such conflict, then any such conflicting text in such incorporated by reference U.S. patents and U.S. patent applications is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A coating composition for prime coat applications, comprising:
one or more acrylic polymers; and
water, wherein application of the coating composition as a prime coat to a pavement structure enhances the physical properties of the pavement structure as compared to conventional prime coat application.

2. The coating composition of claim 1, further comprising carbonaceous compounds.

3. The coating composition of claim 1, wherein at least one of the acrylic compounds comprises a vinyl moiety.

4. The coating composition of claim 1, wherein at least one of the acrylic compounds comprises a vinyl acrylic latex.

5. The coating composition of claim 1, wherein at least one of the acrylic compounds comprises a styrene moiety.

6. The coating composition of claim 1, wherein a solids content of the coating composition ranges from about 50% to about 60%.

7. The coating composition of claim 1, wherein at least one of the vinyl acrylic materials has a pH ranging about 4.0 to about 6.0.

8. The coating composition of claim 1, wherein at least one of the physical properties comprises dry strength.

9. The coating composition of claim 1, wherein at least one of the physical properties comprises wet strength.

10. The coating composition of claim 1, wherein at least one of the physical properties comprises permeability.

11. The coating composition of claim 1, wherein at least one of the physical properties comprises penetration depth.

12. The coating composition of claim 1, wherein composition dries in less than 100 hours.

13. The coating composition of claim 1, where at least one of the acrylic compounds is vinyl acrylic latex.

14. The coating composition of claim 1, wherein a weight ratio of water to at least one of the acrylic compounds is 1 to 3.

15. A method of applying a prime coat to pavement structure, comprising:
providing a coating composition to one or more portions of a pavement structure, wherein the coating composition comprises one or more acrylic compounds; and
curing the pavement structure for a desired period of time.

16. The method of claim 13, wherein the at least one of the portions of pavement structure comprises a roadbed.

17. The method of claim 13, wherein providing one or more portions of coating composition to the pavement structure comprises spraying the coating composition on the portion of pavement structure.

18. A coating composition for fog coat applications, comprising:
one or more spent toners, wherein at least one of the toners is non-black;
one or more acrylic polymers; and
water, wherein application of the coating composition as a fog coat to a pavement structure enhances the physical properties of the pavement structure.

19. The coating composition of claim 16, further comprising carbonaceous compounds.

20. The coating composition of claim 16, wherein at least one of the acrylic compounds comprises a vinyl moiety.

21. The coating composition of claim 16, wherein at least one of the acrylic compounds comprises a styrene moiety.

22. The coating composition of claim 16, wherein a solids content of the coating composition ranges from about 50% to about 60%.

23. The coating composition of claim 16, wherein at least one of the vinyl acrylic materials has a pH ranging about 4.0 to about 6.0.

24. The coating composition of claim 16, further comprising one or more pigments.

25. A pavement structure composition, comprising:
one or more acrylic polymers; and
water;
wherein the coating composition enhances the physical properties of the pavement structure.

26. The composition of claim 25, wherein the composition is suitable as a prime coat.

27. The composition of claim 25, wherein the composition is suitable in fog seal applications.

28. The composition of claim 25, further comprising aggregates, wherein the composition is suitable for a patching material for the pavement structure.

29. The composition of claim 25, further comprising aggregates, wherein the composition forms high friction surface on the pavement structure.

30. The composition of claim 25, wherein the composition is suitable for micro surfacing of the pavement structure.

31. The composition of claim 25, wherein the composition is suitable for slurry sealing of the pavement structure.

32. The composition of claim 25, wherein the composition is suitable to seal cracks in the pavement structure.

33. A coating composition for prime coat applications, comprising:
one or more paraffinic resins; and
water, wherein application of the coating composition as a prime coat to a pavement structure enhances the physical properties of the pavement structure as compared to conventional prime coat application.

34. A coating composition for prime coat applications, comprising:
one or more soybean processing by-products; and
water, wherein application of the coating composition as a prime coat to a pavement structure enhances the physical properties of the pavement structure as compared to conventional prime coat application.

35. A coating composition for prime coat applications, comprising:
one or more one or more vinyl acetate compounds; and
water, wherein application of the coating composition as a prime coat to a pavement structure enhances the physical properties of the pavement structure as compared to conventional prime coat application.

36. A coating composition for prime coat applications, comprising:
one or more acrylonitrile butadiene styrene compounds; and
water, wherein application of the coating composition as a prime coat to a pavement structure enhances the physical properties of the pavement structure as compared to conventional prime coat application.

37. A coating composition for prime coat applications, comprising:
one or more styrene-butadiene rubber compounds; and
water, wherein application of the coating composition as a prime coat to a pavement structure enhances the physical properties of the pavement structure as compared to conventional prime coat application.

38. A coating composition for prime coat applications, comprising:
one or more lignin sulfonates; and
water, wherein application of the coating composition as a prime coat to a pavement structure enhances the physical properties of the pavement structure as compared to conventional prime coat application.

39. A coating composition for prime coat applications, comprising:
magnesium chloride; and
water, wherein application of the coating composition as a prime coat to a pavement structure enhances the physical properties of the pavement structure as compared to conventional prime coat application.

40. A coating composition for prime coat applications, comprising:
calcium chloride; and
water, wherein application of the coating composition as a prime coat to a pavement structure enhances the physical properties of the pavement structure as compared to conventional prime coat application.

41. A method of preparing soil blocks, comprising
providing one or more vinyl acrylic polymers to soil;
mixing the vinyl acrylic polymer with the soil to form a mixture; and
forming the mixture into one or more blocks, wherein the formed block has increased strength properties as compared to an untreated soil block.

42. A method of treating a landfill, comprising:
providing a coating composition to one or more portions of a landfill, wherein at least one of the portions is at a base of the landfill, and wherein the coating composition comprise one or more vinyl acrylic polymers;
allowing the coating composition to dry; and
forming a coating on the base of the landfill so that the base of the landfill is substantially impermeable to water.

43. A method of sealing a landfill, comprising:
providing a coating composition to one or more a closed landfill, wherein the coating composition comprise one or more vinyl acrylic polymers;
allowing the coating composition to dry; and
forming a coating on the top landfill to inhibit release of gas from the landfill.

44. A method of treating a water structure, comprising:
providing a coating composition to one or more portions of a water structure, wherein at least one of the portions is at a base of the water structure, and wherein the coating composition comprise one or more vinyl acrylic polymers;
allowing the coating composition to dry; and
forming a coating on the base of the structure so that the structure is substantially impermeable to water.

45. A method of treating wood, comprising:
providing a coating composition to one or more portions of wood, wherein the coating composition comprise one or more vinyl acrylic polymers; and
forming a coating on the wood so that the wood is substantially impermeable to water.

46. A method for coloring roofing shingles, comprising:
providing one or more vinyl acrylic latex polymers and one or more spent toner or one or more pigments to material suitable for shingle construction; and
forming a shingle.

47. A method of treating wood, comprising:
providing a coating composition to one or more portions of wood, wherein the coating composition comprise one or more styrene-butadiene polymers; and
forming a coating on the wood so that the wood is substantially impermeable to water.

48. A method of inhibiting erosion of land, comprising:
providing a coating composition to one or more portions of land, wherein the coating composition comprise one or more vinyl acrylic polymers;
allowing the coating composition to dry; and
forming a coating on the portion of land so that the erosion of the land is substantially inhibited.

49. A method of marking roads, comprising:
providing a coating composition to one or more portions of a road, wherein the coating composition comprise one or more vinyl acrylic polymers; and
forming a marking on the road with the coating composition.

50. The method of claim 49, wherein the coating composition further comprises one or more spent toners.

51. The method of claim 49, wherein the coating composition further comprises one or more pigments.

52. An asphalt modifier composition, comprising:
asphalt; and
one or more vinyl acrylic polymer latex;
wherein the coating composition enhances low temperature and high temperature engineering properties of asphalt binders used in Paving applications.

53. A method of treating concrete, comprising:
providing a coating composition to one or more portions of wet concrete, wherein the coating composition comprise one or more vinyl acrylic polymers and spent toner; and
allowing the concrete to dry.
